(19) United States
(12) Patent Application Publication
(10) Pub. No.: US 2012/0197652 A1
(43) Pub. Date: Aug. 2, 2012

(54) DETERMINING AN ENTITY'S SHARE OF ECONOMIC CONTRIBUTION AND ENVIRONMENTAL BURDEN

(76) Inventors: Kiara Groves Corrigan, San Francisco, CA (US); Amip J. Shah, Santa Clara, CA (US)

(21) Appl. No.: 13/015,501

(22) Filed: Jan. 27, 2011

(51) Int. Cl. G06Q 10/00

(52) U.S. Cl. 705/1.1

(57) ABSTRACT

Disclosed examples relate to determining an entity's share of economic contribution and environmental burden. In one example, a processor estimates an entity's share of an economic contribution created by an activity relative to multiple entities. In one example, a processor estimates an entity's share of environmental burden caused by an activity relative to multiple entities. In one example, a processor determines an entity's impact related to an activity based on the entity's share of economic contribution and share of environmental burden related to the activity.

### BACKGROUND

There is increasing interest in determining the effects of activities on the environment. For example, a company may attempt to determine the effect of its products on the environment. In some cases, determining information about environmental impact may be a cumbersome task involving detailed analysis of an entity's activities.

### BRIEF DESCRIPTION OF THE DRAWINGS

In the accompanying drawings, like numerals refer to like components or blocks. The drawings describe example embodiments. The drawings show blocks in an example order, but the method of the blocks may be performed in any suitable order. The following detailed description references the drawings, wherein:

FIG. 1 is a block diagram illustrating one example of an electronic device.

FIG. 2 is a flow chart illustrating one example of a method to determine an entity's share of an economic contribution created by an activity.

FIG. 3 is a flow chart illustrating one example of a method to determine an entity's share of an economic contribution created by an activity.

FIG. 4A is a diagram illustrating one example of determining an entity's share of an economic contribution created by an activity.

FIG. 4B is a diagram illustrating one example of determining an entity's share of an economic contribution created by an activity.

FIG. 5 is a block diagram illustrating one example of an electronic device.

FIG. 6 is a flow chart illustrating one example of a method to estimate an entity's share of environmental burden caused by an activity.

FIG. 7 is a flow chart illustrating one example of a method to estate an entity's share of environmental burden caused by an activity.

FIG. 8A is a diagram illustrating one example of estimating an entity's share of environmental burden caused by an activity.

FIG. 8B is a diagram illustrating one example of estimating an entity's share of environmental burden caused by an activity.

FIG. 9 is a block diagram illustrating one example of an electronic device.

FIG. 10 is a flow chart illustrating one example of a method to estimate an entity's impact related to an activity.

FIG. 11 is a diagram illustrating one example of estimating an entity's impact.

FIG. 12 is a diagram illustrating one example of a chart for determining an entity's risk of regulation based on the entity's impact.

### DETAILED DESCRIPTION

In one example, a computer system estimates a share of an entity's economic contribution related to an activity. For example, the relative share of a company's economic contribution related to its activities may be compared to the economic contribution of members of the company's supply chain. The result may indicate to what degree a company is responsible for the economic contribution of its activities.

In one example, a computer system determines a share of an entity's environmental burden related to an activity. The share of a company's environmental burden related to an activity may be compared to the environmental burden of members of the company's supply chain. This may show the percentage of environmental harm caused by an activity that is directly attributable to the company versus the percentage attributable to other parties, such as members of the supply chain.

In one example, an entity's share of economic contribution and environmental burden may be determined using financial data, such as financial data publicly available in an annual report. Using publicly available data may allow for third parties to determine an entity's share of its economic contribution and environmental burden.

In one example, a computer system determines an entity's social impact by comparing the entity's economic contribution to the entity's environmental burden. For example, an entity may create a large economic contribution and have a small environmental burden, or cause a large amount of environmental harm to create a small economic contribution. The relationship may be used, for example, to set goals for an entity or to determine the entity's risk of experiencing environmental regulation. For example, an entity with a large amount of environmental harm for a small economic gain may be more at risk for environmental regulation.

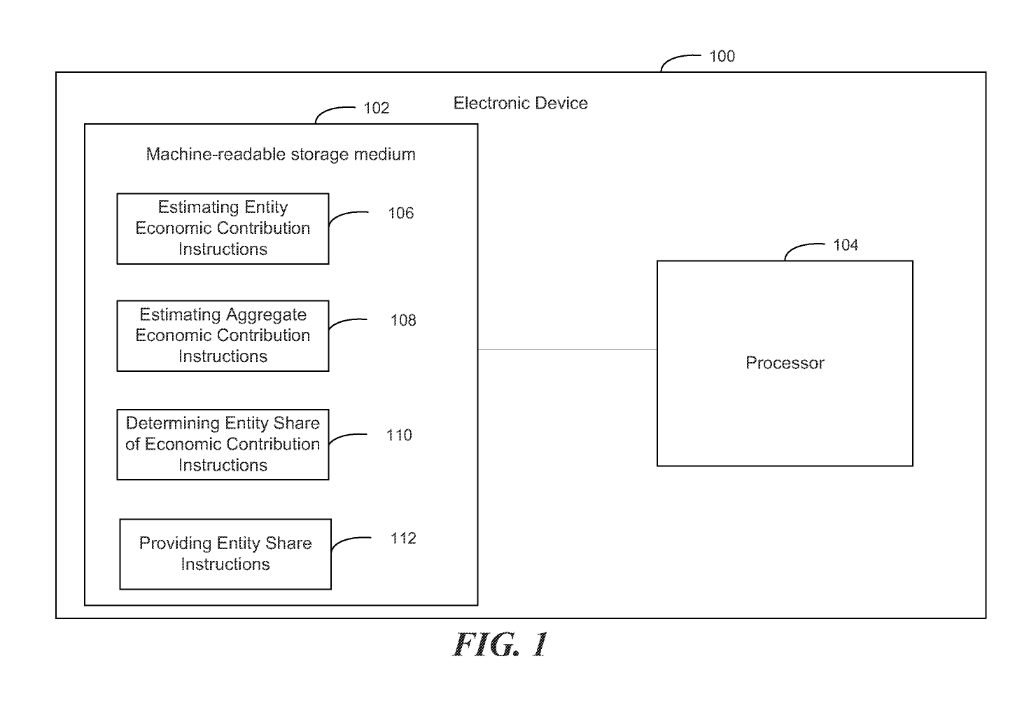

FIG. 1 is a block diagram illustrating one example of an electronic device 100. The electronic device may be any suitable electronic device, such as a server, personal computer, or mobile computing device. The electronic device 100 includes, for example, a machine-readable storage medium 102 and a processor 104. In one example, the electronic device 100 may be used to determine an entity's share of economic contribution related to an activity. For example, the electronic device 100 may determine a share of value add created by a company's products and services. The economic contribution may indicate the difference between the cost to produce a product and the price at which the product is sold. The share of economic contribution may represent the economic value of a product that is due to a company's activity. In some cases, a product may be part of a supply chain of multiple companies, and each company may add value to the product, such as where a computer manufacturer buys a processor from a separate company to include in its computers.

The processor 104 may be any suitable processor, such as a central processing unit (CPU), a semiconductor-based microprocessor, or any other device suitable for retrieval and execution of instructions. In one example, the electronic device 100 includes logic instead of or in addition to the processor 104. As an alternative or in addition to fetching, decoding, and executing instructions, the processor 104 may include one or more integrated circuits (ICs) or other electronic circuits that comprise a plurality of electronic components for performing the functionality described below. In one implementation, the electronic device 100 includes multiple processors. For example, one processor may perform some functionality and another processor may perform other functionality.

The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium. The machine-readable storage medium 102 may include instructions executable by the processor 104. The machine-readable storage medium 102 may be included in the system memory of an electronic device including the processor 104 where program instructions installed. In one example, the machine-readable storage medium 102 is located on a memory of a server where installation files may be downloaded and installed.

The machine-readable storage medium 102 may include instructions executable by the processor 104. For example, the machine-readable storage medium 102 may include estimating entity economic contribution instructions 106, estimating aggregate economic contribution instructions 108, determining entity share of economic contribution instructions 110, and providing entity share instructions 112. The estimating entity economic contribution instructions 106 may include instructions to estimate an entity's economic contribution to an activity, such as the value add created by the entity's performance of an activity. The estimating aggregate economic contribution instructions 108 may include instructions to estimate an aggregate economic contribution created by an activity, such as a contribution created by the entity as well as other entities. The determining entity share of economic contribution instructions 110 may include instructions to determine an entity's economic contribution compared to the determined aggregate economic contribution. The providing entity share instructions 112 may include instructions for providing the entity's determined share of economic contribution related to the activity. For example, the entity share information may be stored, transmitted, or displayed.

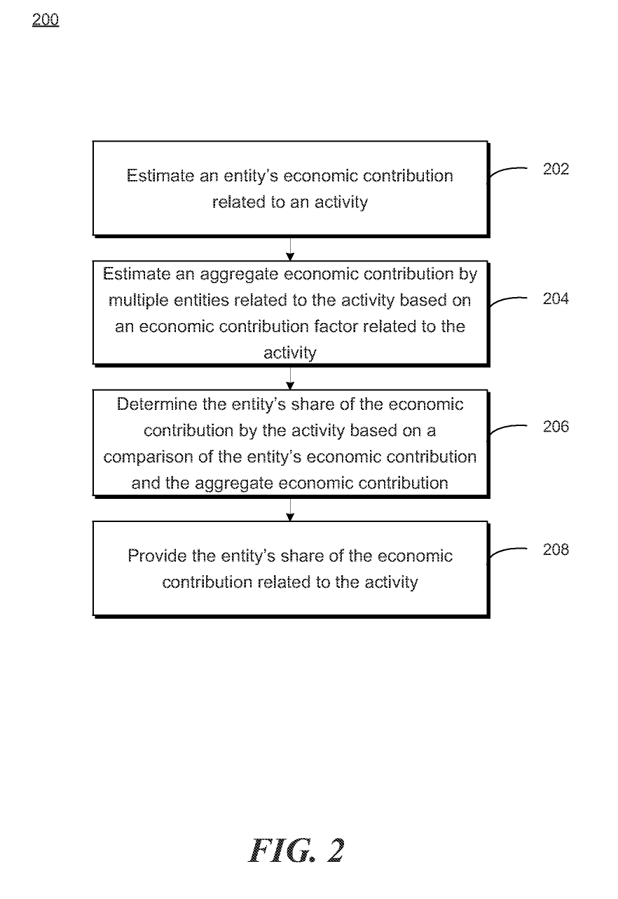

FIG. 2 is a flow chart illustrating one example of a method 200 to determine an entity's share of an economic contribution created by an activity. For example, an entity's share of an economic contribution may include the entity's economic contribution compared to a total contribution by an activity, such as a contribution by multiple entities. The share of an economic contribution may be compared to an environmental burden to determine if the two are proportional. For example, a small economic contribution causing large environmental problems may be found to be less acceptable than a larger economic contribution causing large environmental problems. The method 200 may be executed, for example, on the electronic device 100.

Beginning at 202, a processor estimates an entity's economic contribution related to an activity. The processor may be any suitable processor, such as a processor associated with a server. The processor may be, for example, the processor 104, executing the estimating entity economic contribution instructions 106.

The entity may be any suitable entity, such as a company, business unit, country, or government institution. In some cases, the entity may be divided into multiple subsets, such as a company composed of multiple business units or a government institution composed of multiple agencies. In one example, the economic contribution of each subset is estimated and added together.

The activity may be any suitable activity, such as a profit or non-profit activity. The activity may be the sole activity of the entity or one of many activities related to the entity. The activity may be, for example, producing a product, performing a service, or performing support operations.

The economic contribution may be any suitable economic contribution. For example, the economic contribution may be a value added by the activity, such as the value added by the entity's contribution to the activity. The value added may represent, for example, the value that the entity contributed to the activity beyond the money and resources that the entity contributed to the activity. For example, for a product with machine readable instructions (such as but not limited to a software product), the value added may be a high value because the intellectual value added by the software code, or other type of machine readable instructions, may be much greater than the hardware and salaries input to create the software code (or other type of machine readable instructions).

The processor may estimate an entity's economic contribution related to an activity in any suitable manner. In one example, the processor uses financial data related to the entity to determine the entity's economic contribution to the activity. For example, the processor may compare the financial gain to the entity due to the activity versus the cost to the entity related to the entity. The processor may compare the entity's revenue to the entity's cost of sales, such as the cost to produce and sell a product or service. The financial data used to determine an entity's economic contribution may in some cases be available in publicly available financial data, such as a publicly traded company's financial reports. Using the type of financial data that may be publicly available may result in an economic contribution being more easily determined by an outside party without proprietary data related to the entity.

Moving to 204, the processor estimates an aggregate economic contribution by multiple entities related to the activity based on an economic contribution factor related to the activity. The aggregate economic contribution by the multiple entities may be any suitable aggregate economic contribution. For example, the aggregate economic contribution may include an economic contribution of other members of a supply chain, other business units, or other entities assisting the entity in the activity.

The economic contribution factor related to the activity may be any suitable economic contribution factor. In one example, the economic contribution factor is determined by the processor. In one example, the economic contribution factor is determined separately and received by the processor via a network or retrieved by the processor from a storage. The economic contribution factor may be determined based on an economic model. In one example, the economic contribution factor is determined from an Economic Input Output (EIO) model that reflects interdependencies in an economy. The economic contribution factor may be specific to the particular entity or may be related to the performance of the activity in general.

The processor may estimate the aggregate economic contribution in any suitable manner. In one example, the processor executes the estimating aggregate economic contribution instructions 108. The aggregate economic contribution may be determined based on financial information related to the entity. For example, financial information related to the entity may be manipulated by the economic contribution factor.

Continuing to 206, the processor determines the entity's share of the economic contribution by the activity based on a comparison of the entity's economic contribution and the aggregate economic contribution. The processor may determine the entity's share of the economic contribution in any suitable manner. For example, the entity's share of the economic contribution may be the percentage of the entity's economic contribution compared to the aggregate economic contribution.

Proceeding to 208, the processor provides the entity's share of the economic contribution related to the activity. The processor may, for example, execute the providing entity share instructions 112. The processor may provide the entity's share of the economic contribution in any suitable manner. For example, the processor may transmit the information about the entity's share to another electronic device, store the information, or display the information an electronic device associated with the processor or on a separate electronic device. The entity's share of the economic contribution may be used to determine the value that the entity provides related to the activity. The value may be compared to costs created by the entity's performance of the activity.

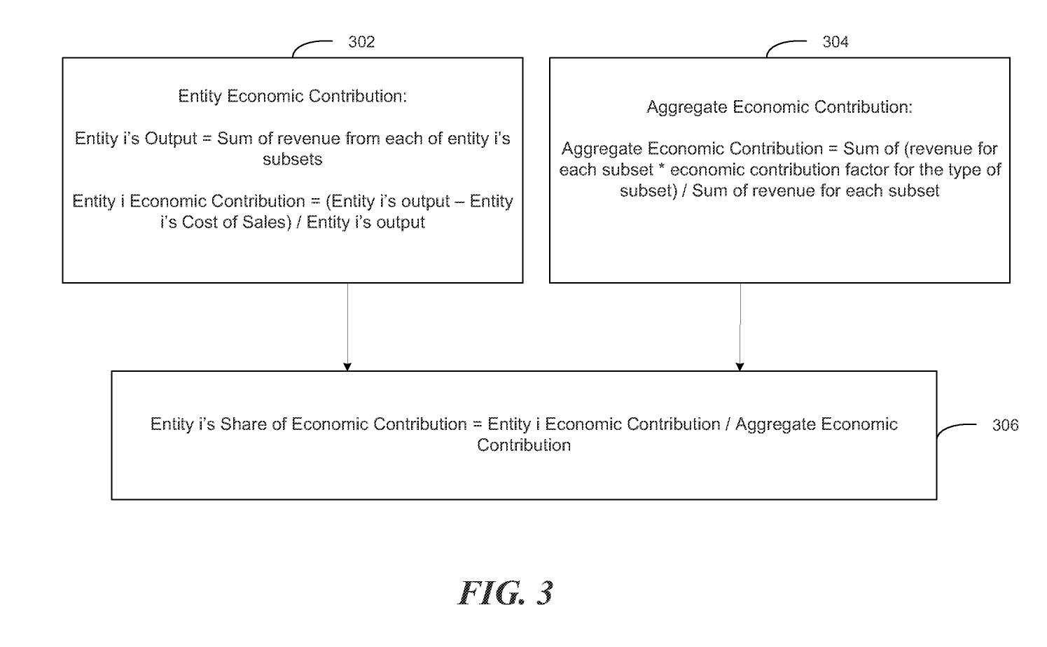

FIG. 3 is a flow chart illustrating one example of a method to determine an entity's share of an economic contribution created by an activity. Block 302 shows a method for determining an entity's economic contribution, and block 304 shows a method for determining an aggregate economic contribution. Block 306 shows a method for using the information determined in blocks 302 and 304 to determine the entity's share of the economic contribution.

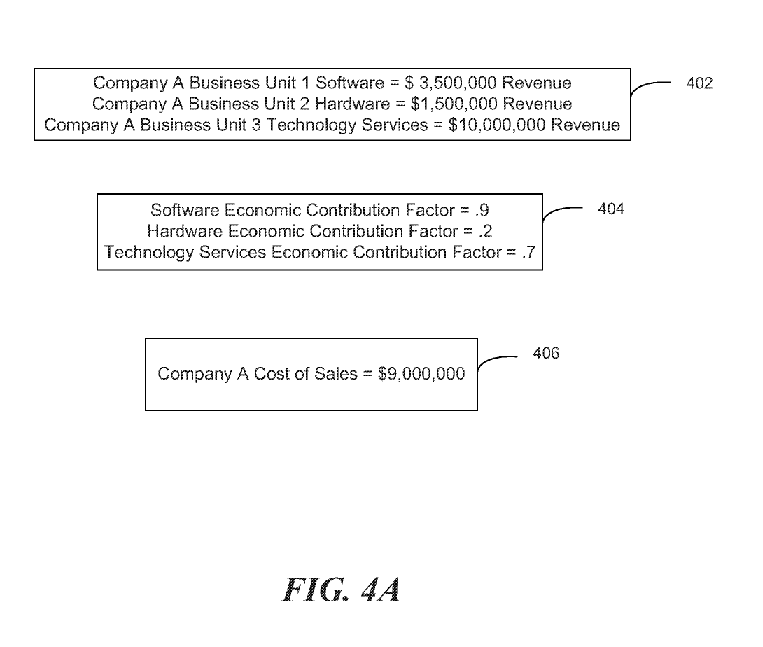

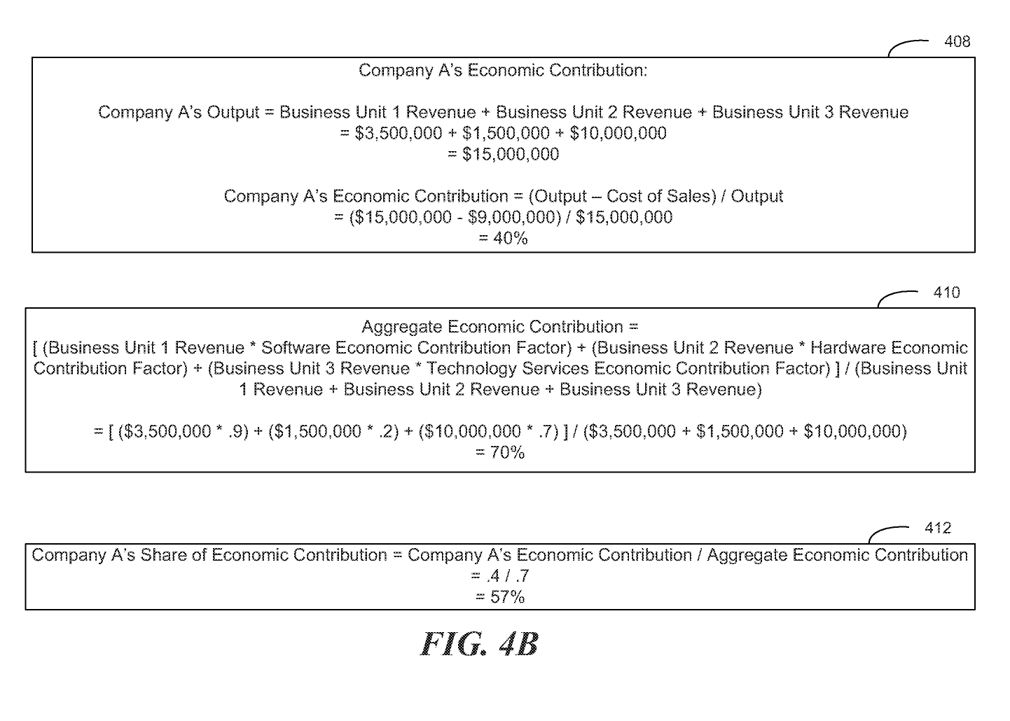

FIGS. 4A and 4B are diagrams illustrating one example of determining an entity's share of an economic contribution created by an activity. FIG. 3 is discussed in conjunction with the example provided in FIGS. 4A and 4B. FIG. 4A includes information about an entity Company A. Block 402 shows that Company A has three separate business units and a revenue value associated with each. For example, the business unit 1 for software has revenue of $3,500,000. Block 404 shows an economic contribution factor associated with each of Company A's business units. For example, an economic contribution factor for software, hardware, and technology services are each provided. Block 406 shows the cost of sales for Company A is $9,000,000.

Referring back to FIG. 3, block 302 shows a method for estimating an entity's environmental contribution using financial information related to the entity. The entity's output may be used to estimate the entity's economic contribution. The output may be based on the entity's revenue. If the entity is composed of multiple subsets, such as multiple business units, the revenue associated with each subset may he combined to determine the entity's output. The entity's economic contribution may then be determined based on the entity's output. For example, the entity's economic contribution may be estimated based on the difference between the entity's output and the entity's cost of sales, representing the difference between the reward the entity receives for the activity minus the cost the entity pays to perform the activity. The output minus the cost of sales may then be adjusted by dividing by the output to normalize the result.

Block 408 of FIG. 48 shows an example of estimating Company A's economic contribution using the method shown in block 302. The output of Company A is determined by adding the revenue of each of Company A's three business units. The total revenue is $15,000,000. Company A's economic contribution is determined by subtracting the cost of sales, $9,000,000, from the total revenue and dividing by the total revenue. Company A's economic contribution is determined to be 0.4 or 40%.

Referring back to FIG. 3, block 304 shows a method for estimating the aggregate economic contribution. The aggregate economic contribution is determined by multiplying the output of each entity subset by the associated economic contribution factor and adding the result for each subset. The result is then normalized by dividing by the total output for the entity.

Block 410 shows estimating the aggregate economic contribution for Company A. Each of the three business unit revenues are multiplied by their associated economic contribution factors. The information for each of the three business units is then added together. The result is divided by the sum of the revenue for each of the three business units. The aggregate economic contribution for the activity is 0.7 or 70%.

Referring back to FIG. 3, block 306 shows a method for determining an entity's share of economic contribution. The entity's share may be determined by dividing the entity's economic contribution by the aggregate economic contribution. Block 412 of FIG. 4 shows determining Company A's share of the economic contribution. Company A's economic contribution is divided by the aggregate economic contribution. Company A's share of the economic contribution is 0.57 or 57%. The share of economic contribution indicates that Company A is itself responsible for more than half of the value added by its products and services.

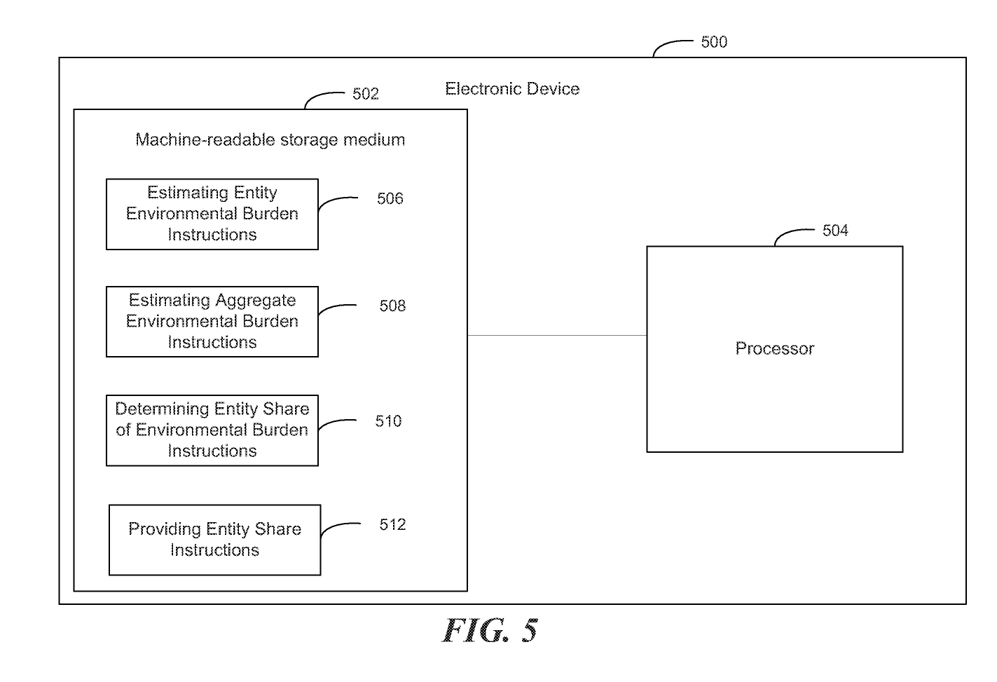

In one example, a processor determines an entity's share of an environmental burden related to an activity. FIG. 5 is a block diagram illustrating one example of an electronic device 500. The electronic device 500 may be any suitable electronic device, such as a mobile computing device, server, or personal computer. The electronic device 500 includes a processor 504 and a machine-readable storage medium 502. The electronic device 500 may be used to determine an entity's share of an environmental burden related to an activity. For example, a company may cause environmental harm, such as carbon dioxide emissions, water usage, or electricity usage, to produce its products or perform its services. In some cases, some of the environmental harm caused may be attributable to other parties. For example, an entity may sell computers, and the entity may cause an amount of carbon dioxide emissions related to its activities to make and sell computers. However, other members of the entity's supply chain may perform activities related to the making and selling of the computers, such as transporting the computers for the entity or selling the entity portions of the hardware. As a result, the entity itself may be responsible for a share of the environmental burden related to the activity, and members of the supply chain may be responsible for a share of the environmental burden related to the activity.

The processor 504 may be any suitable processor, such as a central processing unit (CPU), a semiconductor-based microprocessor, or any other device suitable for retrieval and execution of instructions. For example the processor 504 may retrieve and execute instructions stored in the machine-readable storage medium 502. The machine-readable storage medium 502 may be any suitable machine readable medium, such as an electronic, magnetic, optical, or other physical storage device that stores executable instructions or other data (e.g., a hard disk drive, random access memory, flash memory, etc.).

The machine-readable storage medium 502 may include estimating entity environmental burden instructions 506, estimating aggregate environmental burden instructions 508, determining entity share environmental burden 510, and providing entity share instructions 512. The estimating entity environmental burden instructions 506 may be instructions to estimate the environmental harm attributable to the entity. The estimating aggregate environmental burden instructions 508 may be instructions to estimate the total environmental burden caused by the activity both by the particular entity and other entities. The determining entity share environmental burden 510 may be instructions to compare the entity's environmental burden to the aggregate environmental burden. The providing entity share instructions 512 may be instructions to provide the determined share of the environmental burden, such as by transmitting, displaying, or storing it.

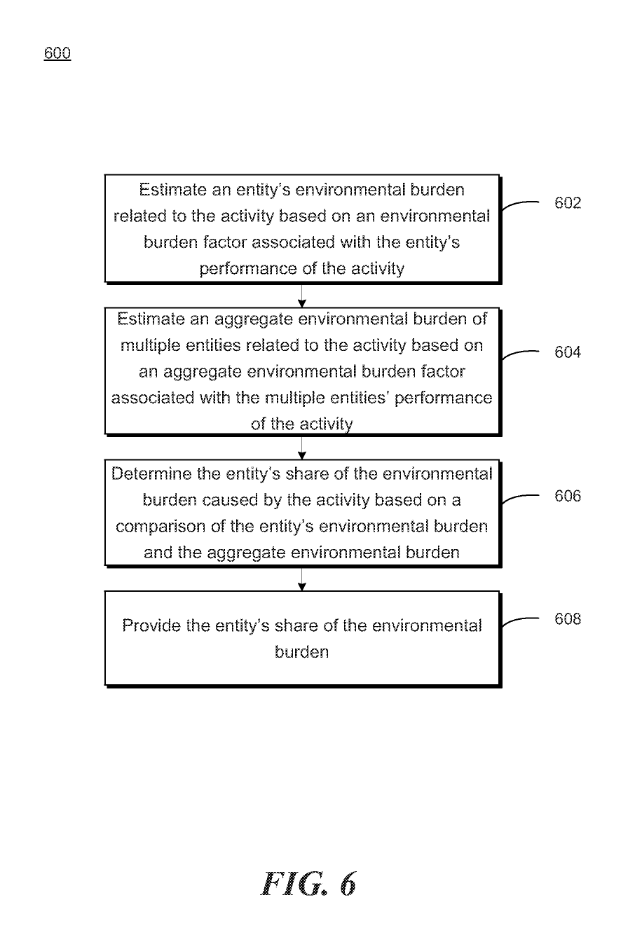

FIG. 6 is a flow chart illustrating one example of a method 600 to determine an entity's share of environmental burden caused by an activity. The processor may determine the entity's environmental burden and determine and aggregate environmental burden caused by an activity. The processor may compare the entity's environmental burden to the aggregate environmental burden to determine the entity's share of the environmental burden. The method 600 may be implemented, for example, by the electronic device 500.

Beginning at 602, the processor estimates an entity's environmental burden related to the activity based on an environmental burden factor associated with the entity's performance of the activity. The processor may be any suitable processor, such as the processor 504. The entity may be any suitable entity, such as an organization, company, business unit, region, non-profit organization, or government. The activity may be any suitable activity. The activity may be any level of an activity, such as manufacturing computers or manufacturing hard drives for computers. In some cases the entity may be involved in multiple activities, and the environmental burden of each activity may be determined.

The environmental burden factor may be any suitable information indicating an environmental burden. For example, the environmental burden factor may indicate environmental burden per dollar of output, such as 5 tons of carbon dioxide emissions per $1 of a particular type of output. In some cases, the entity may have different environmental burden factors for different activities, such as 4 tons of carbon dioxide emissions for selling a first type of item and 10 tons of carbon dioxide emissions for selling a second type of item. The environmental burden factor may be calculated by the processor, or the processor may receive it from another source. The environmental burden factor may be related to a particular type of environmental harm, such as carbon emissions, water usage, or electricity usage. In some cases, the processor may determine multiple types of environmental burden related to the entity. Alternatively, the processor may combine multiple types of environmental burden related to the entity into a single score through some type of weighting scheme or other mathematical manipulation. The environmental burden factor may be calculated using an economic environmental model, such as the Economic Input Output Life Cycle Analysis (EIO-LCA) model. In one implementation, an economic environmental model may be used and the environmental burden may then be tailored to the entity. For example, the entity may use more environmental practices than typical of an industry or may sell products in a location with strict environmental regulations. The environmental burden factor may be adjusted to indicate that the entity outsources some processes associated with the activity. For example, the entity may receive some items from or outsource some services to other entities.

The processor may determine an entity's environmental burden in any suitable manner. For example, the processor may manipulate information about the entity's output by the environmental burden factor. In some cases, the processor may use financial information, such as revenue to indicate the entity's output. The financial information may in some cases be publicly available, such as in a publicly traded company's financial report. The processor may, for example, multiply the entity's revenue related to an activity by an environmental burden factor indicating the amount of an environmental harm per dollar of revenue.

Proceeding to 604, the processor estimates an aggregate environmental burden of multiple entities related to the activity based on an aggregate environmental burden factor associated with the multiple entities' performance of the activity. The multiple entities may be any suitable entities. In some cases, the multiple entities may include the first entity. The multiple entities may be related to the first entity, such as other entities in the supply chain. The activity may be, for example, the same activity or a similar activity as the activity related to the entity environmental burden factor.

The aggregate environmental burden factor may be any suitable environmental burden factor. In some cases, the aggregate environmental factor may be a representative value indicating an average environmental burden. The aggregate environmental burden may indicate a type of environmental burden per dollar of output, such as kilowatts of electricity per $1 of output. The aggregate environmental burden factor may be determined by the processor, or the processor may retrieve or receive it, such as from a third party. The aggregate environmental burden factor may be determined using an economic environmental model, such as the Economic Input Output Life Cycle Analysis (EIO-LCA) model. The aggregate environmental burden factor may be calculated using the same model used to determine the entity environmental burden factor. In one implementation, the entity environmental burden factor and the aggregate environmental burden factor are calculated using the same model, and the entity environmental burden factor is then adjusted for factors specific to the entity.

The processor may determine the aggregate environmental burden in any suitable manner. In one implementation, the processor uses information related to the entity and manipulates it with the aggregate environmental burden factor. The processor may use financial information related to the entity. In some implementations, the processor determines the aggregate environmental burden using the same entity financial information used to determine the entity environmental burden. For example, the processor may multiply the entity financial information by the aggregate environmental burden factor.

Moving to 606, the processor determines the entity's share of the environmental burden caused by the activity based on a comparison of the entity's environmental burden and the aggregate environmental burden. The processor may determine the entity's share of the environmental burden in any suitable manner. For example, the processor may divide the entity's environmental burden by the aggregate environmental burden. The entity's share of the environmental burden may be, for example, the percentage or ratio of the environmental burden of an activity attributable to the entity. For example, if an entity outsources certain portions of an activity, the entity's environmental burden may be lower.

Continuing to 608, the processor provides the entity's share of the environmental burden. For example, the processor may transmit or store the environmental burden information. The processor may make the share of environmental burden information available to a user, such as by displaying it on a display device or transmitting it to another electronic device.

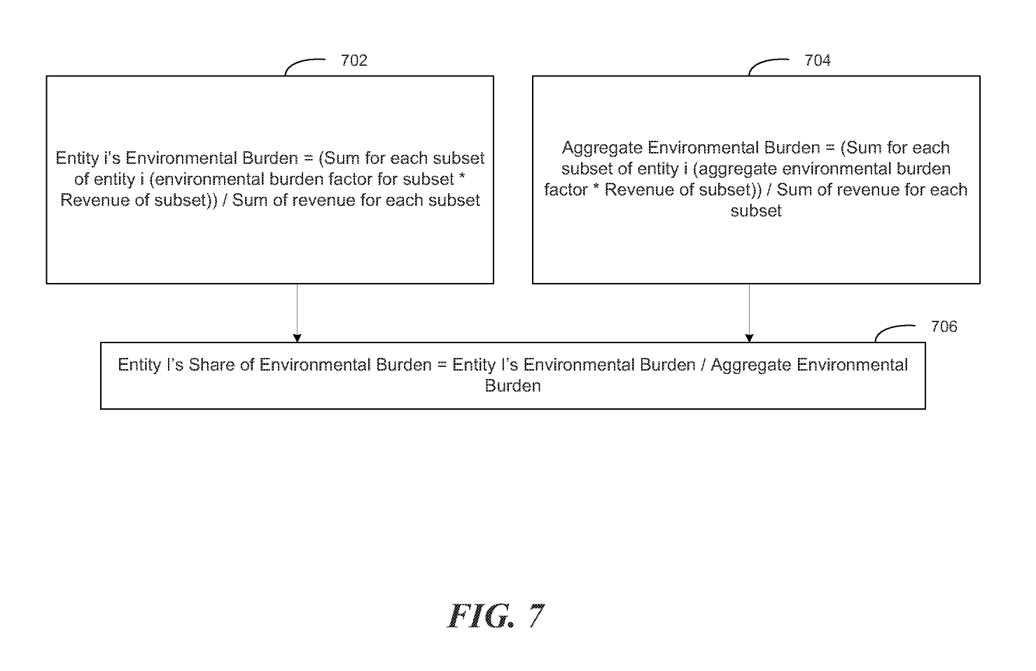

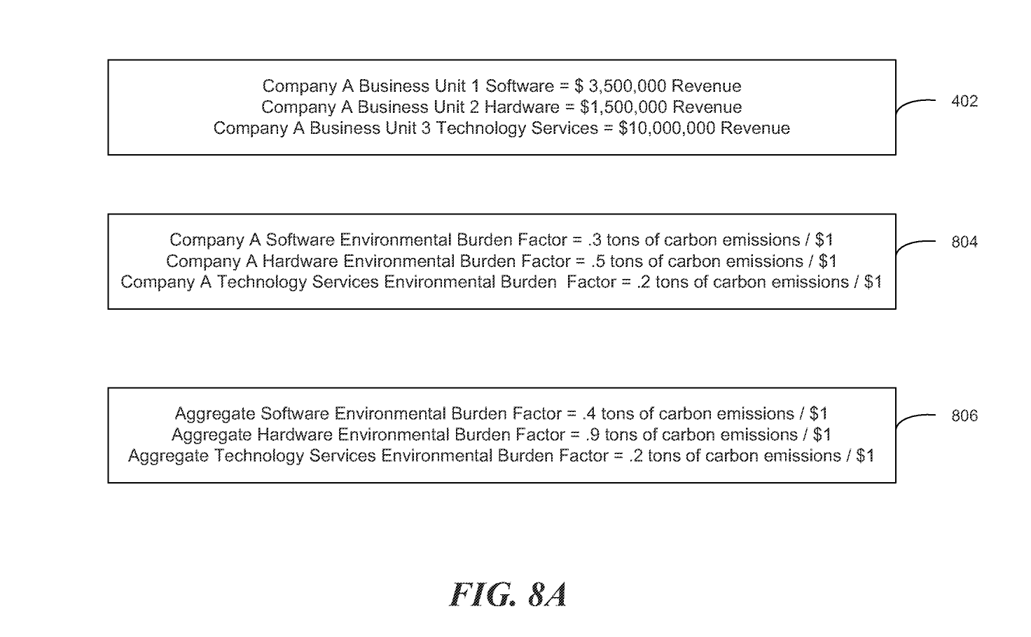

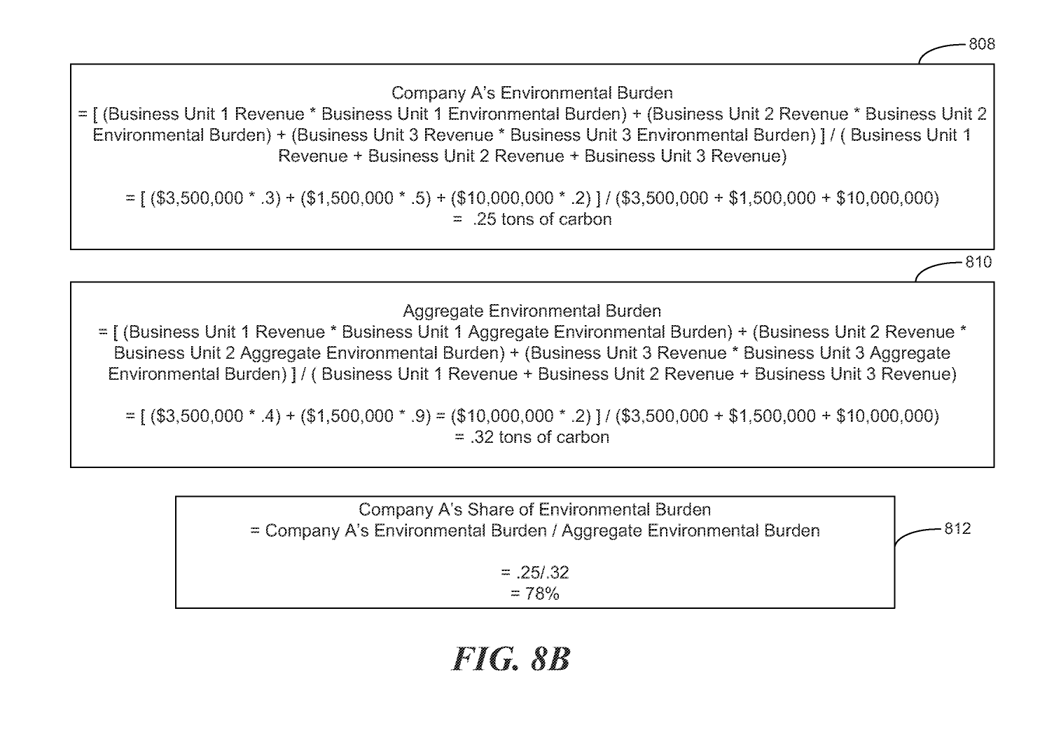

FIG. 7 is a flow chart illustrating one example of a method to determine an entity's share of environmental burden caused by an activity. Block 702 shows a method for estimating the entity's environmental burden related to an activity, block 704 shows a method for estimating the aggregate environmental burden related to the activity, and block 706 shows determining a method for the entity's share of the environmental burden related to the activity. FIG. 7 is discussed in conjunction with the example provided in FIGS. 8A and 88. FIG. 8A is a diagram illustrating one example of determining an entity's share of environmental burden caused by an activity. Block 402 shows revenue information for Company A from FIG. 4. Company A has three business units. Block 804 shows an entity environmental burden factor related to each of Company A's business units. For example, for Company A's software business unit 1, the environmental burden factor is 0.3 tons of carbon $1 revenue. Block 806 shows an aggregate environmental factor corresponding to each of Company A's business units. For example, the aggregate environmental burden factor associated with software is 0.4 tons of carbon/$1 revenue.

Referring back to FIG. 7, block 702 shows a method for estimating the entity's environmental burden. To determine an entity i's environmental burden, a processor multiplies an environmental burden factor relevant to each subset of the entity by the revenue associated with each subset of the entity and adds the results. The processor then divides by the sum of the revenue associated with each subset.

Block 808 of FIG. 8B shows an example of estimating Company A's environmental burden using the method of block 702. Each business unit revenue amount is multiplied by its corresponding environmental burden factor. For example, for business unit 2 for hardware, the revenue $1,500,000 is multiplied by the corresponding environmental burden factor 0.5 tons of carbon/$1. The total for each business unit is then added. The total is divided by the sum of the revenue for the three business units to normalize the result. The resulting environmental burden for Company A is 0.25 tons of carbon.

Referring back to FIG. 7, block 704 shows a method for estimating an aggregate environmental burden for an activity. For example, for each subset of an entity the revenue for the subset may be multiplied by a corresponding aggregate environmental burden factor. The result for each subset may be added together. The sum may be divided by the total revenue of the entity to normalize the result.

Block 810 of FIG. 8B shows an example of determining an aggregate environmental burden for the activities of Company A using the method of block 704 of FIG. 7. The revenue for each of the three business units is multiplied by the corresponding aggregate environmental burden factor. For example, for the hardware business unit, the revenue of $1,500,000 is multiplied by the aggregate environmental burden factor of 0.9 tons of carbon/$1 revenue. The result for each business unit is added together. The total is then divided by the sum of the revenue for each of the three business units. The result is 0.32 tons of carbon in aggregate for Company A's activities.

Referring back to FIG. 7, block 706 describes determining an entity's share of environmental burden. For example, the entity's environmental burden may be divided by an aggregate environmental burden. Block 812 of FIG. 8B shows determining the share of environmental burden for Company A by dividing Company A's environmental burden of 0.25 by the aggregate environmental burden 0.32. Company A's share of environmental burden is 78%.

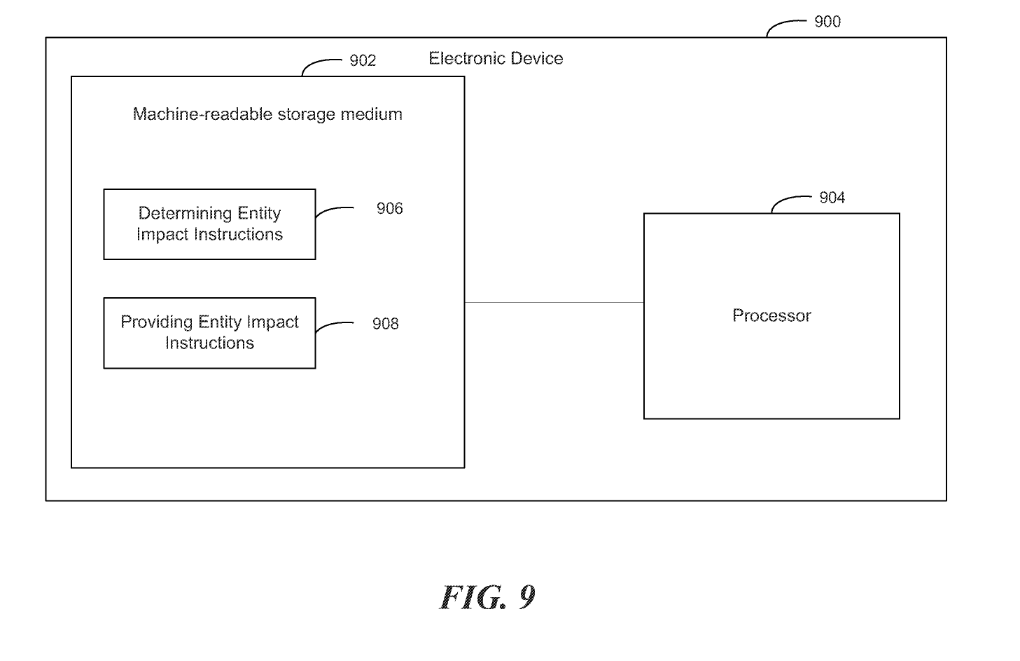

FIG. 9 is a block diagram illustrating one example of an electronic device 900 for determining an entity's impact related to an activity. The electronic device 900 may be any suitable electronic device, such as a personal computer, server, or mobile computing device. The electronic device 900 may include a machine-readable storage medium 902 and a processor 904. The processor 904 may be any suitable processor, such as a central processing unit (CPU), a semiconductor-based microprocessor, or any other device suitable for retrieval and execution of instructions. The machine-readable storage medium 902 may be any suitable machine readable medium, such as an electronic, magnetic, optical, or other physical storage device that stores executable instructions or other data (e.g., a hard disk drive, random access memory, flash memory. etc.). The machine-readable storage medium 902 may be, for example, a computer readable non-transitory medium.

The machine-readable storage medium 902 may include determining entity impact instructions 906 and providing entity impact instructions 908 executable by the processor 904. The determining entity impact instructions may include instructions to determine an impact of an entity. The impact may be determined, for example, by comparing the economic contribution created by the entity to the environmental burden caused by the entity. The providing entity impact instructions 908 may include instructions to provide the entity impact information, such as by displaying, storing, or transmitting it.

In one example, the same electronic device that determines an impact of an entity also estimates one or both of the share of the economic contribution of the entity and the share of the environmental burden of the entity. For example, the functionality of the electronic devices 100, 500, and 900 may be combined. In one example, an electronic device estimates a share of economic contribution of the entity and a share environmental burden of the entity and sends the information to a second electronic device that uses the information to determine the impact of the entity.

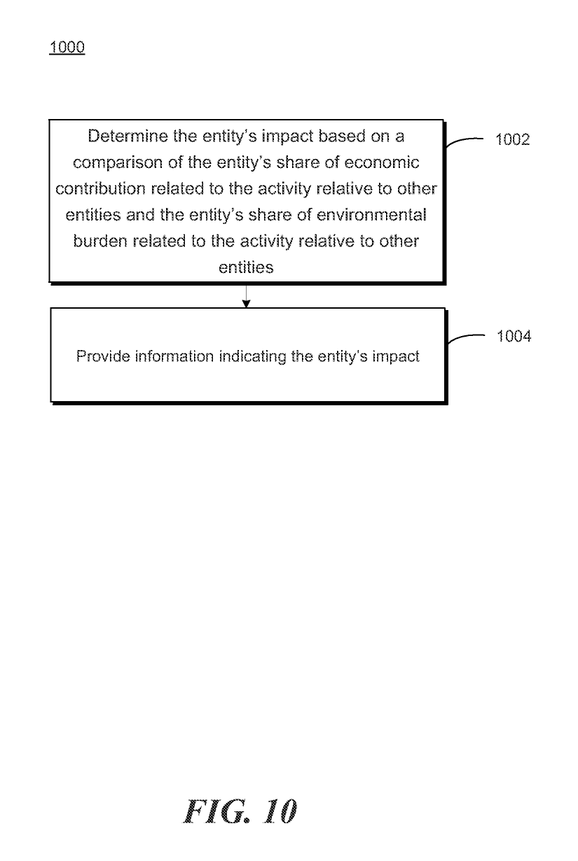

FIG. 10 is a flow chart illustrating one example of a method 1000 to determine an entity's impact related to an activity. The impact may he for example, a social impact or sustainability metric. A processor may compare an entity's economic contribution related to an activity to an entity's environmental burden related to an activity and determine the entity's impact based on the comparison. The comparison may indicate for example the ratio between the entity's economic contribution created and environmental burden caused. The processor may provide the impact information, such as by transmitting, storing, or displaying it. The method 1000 may be executed, for example, using the apparatus 900 of FIG. 9.

Beginning at 1002, a processor compares the entity's share of economic contribution related to the activity relative to other entities and the entity's share of environmental burden related to the activity relative to other entities. The processor may be any suitable processor, such as the processor 904 in FIG. 9. The processor may receive information about the entity's share of economic contribution related to an activity, such as from a storage or from another electronic device. In some implementations, the processor calculates the entity's share of economic contribution. The processor may receive information about the entity's share of environmental burden or calculate the entity's share of environmental burden.

The processor may compare the entity's share of economic contribution to the entity's share of environmental burden in any suitable manner. For example, the processor may determine a difference between the entity's share of economic contribution and environmental burden. In one example, the processor determines a ratio between the entity's share of economic contribution and the entity's share of environmental burden.

The impact may be determined by dividing an entity's share of economic contribution by an entity's share of environmental burden. An impact level of 1 may indicate that the share of an entity's economic contribution is equal to its share of environmental burden. An impact level of greater than 1 may indicate that the share of economic contribution is greater than the share of environmental burden. It may be desirable for an entity to have an impact level of less than 1. An impact level of greater than 1 may indicate that an entity's share of environmental burden is greater than its share of economic contribution.

The entity's impact may indicate a relationship between the value created by incurring the environmental cost. For example, the share of economic contribution may be correlated to marginal benefit, and the share of environmental burden may be correlated to marginal cost. It may be desirable for the share of economic contribution and share of environmental burden to be equal or approximately equal. An economic contribution significantly less than the environmental burden may indicate that an entity is causing a larger amount of environmental harm for a smaller benefit that may not be justified by the level of environmental harm. In a supply chain setting, the impact may indicate whether the particular value added by the entity is proportional to the environmental burden related to the entity's involvement in the supply chain.

Practical applications of the impact information include, for example, setting environmental goals. Environmental goals may be set based on whether an entity's environmental burden is proportional to the value the entity adds rather than based on exact environmental burden target. For example, an environmental goal could be to have a particular ratio of the share of environmental burden to the share of environmental burden. An entity's impact may be compared to other entities in a supply chain to determine which entities provide a large amount of value for their burden and which entities provide a small amount of value for their burden.

Continuing to 1004, the processor provides information indicating the entity's impact. For example, the processor may execute the providing entity impact instructions 908 from FIG. 9. The processor may transmit the impact information to another electronic device, store the information, or provide the information to the user, such as by displaying it on a display device.

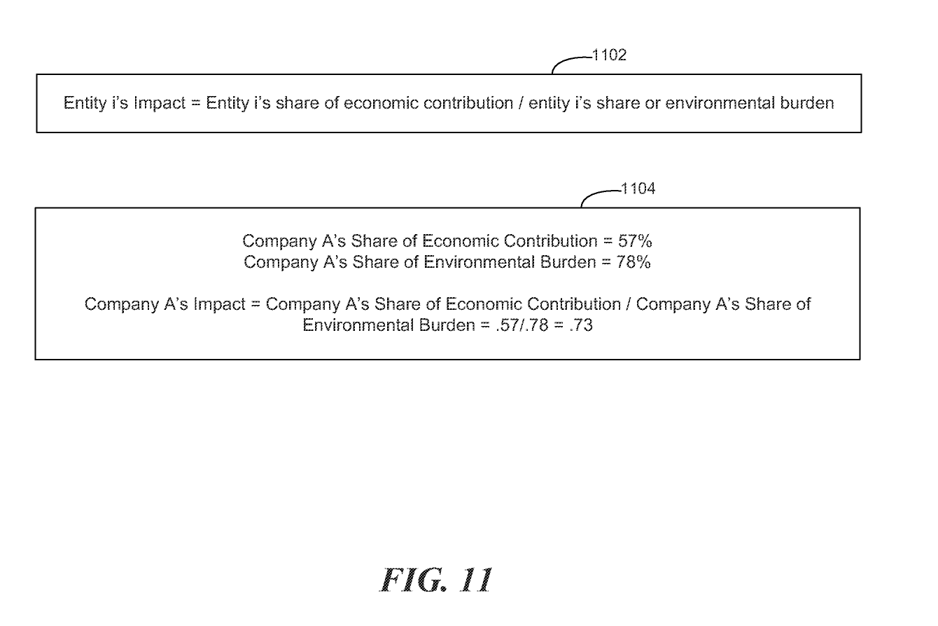

FIG. 11 is a diagram illustrating one example of determining an entity's impact. Block 1102 shows a method for determining an entity's impact. For example, an entity's economic contribution may be divided by an entity's environmental burden. Block 1104 shows determining the impact of Company A. Company A's economic contribution from block 412 of FIG. 4B is divided by Company A's environmental burden from block 808 of FIG. 86. The result is 0.78. The impact level indicates that Company A's share of environmental burden is greater than Company A's economic contribution.

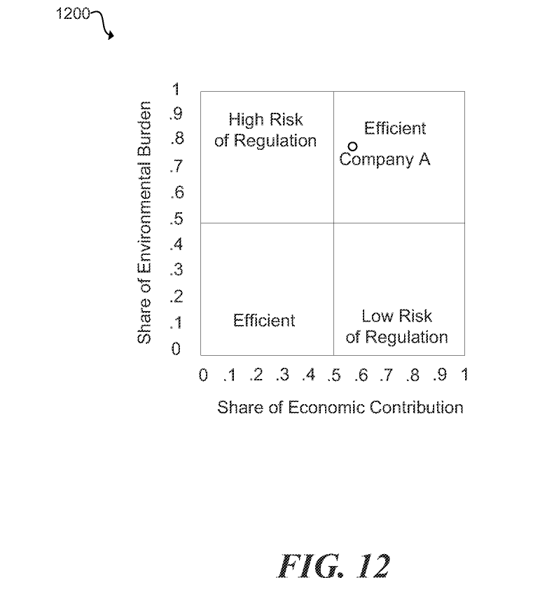

FIG. 12 is a diagram illustrating one example of a chart 1200 for determining an entity's risk of regulation based on the entity's impact. The chart 1200 shows an entity's share of environmental burden on the y-axis, and an entity's share of economic contribution on the x-axis. The chart 1200 shows four quadrants. The upper left quadrant includes high share of environmental burden and low share of economic contribution. The upper right quadrant includes high share of environmental burden and high share of economic contribution. The lower left quadrant includes low share of environmental burden and low share of economic contribution. The lower right quadrant includes low share of environmental burden and high share of economic contribution. Company A is plotted on the chart with a share economic contribution of 0.57 and a share of environmental burden of 0.78. Company A is in the upper right quadrant indicating that Company A's ratio is sufficient such that Company A does not have a high risk of regulation.

Comparing an entity's share of economic contribution and environmental burden may be used to evaluate whether the environmental harm caused by an entity is justified by the value provided by the entity. The comparison may be used, for example, to set environmental goals, to determine where to add new environmental regulations, or to evaluate how changes in a supply chain may reduce an environmental footprint.

1. An electronic device for determining an entity's share of an economic contribution created by an activity, comprising:
a processor to:
estimate the entity's economic contribution related to the activity;
estimate an aggregate economic contribution by multiple entities related to the activity based on an economic contribution factor related to the activity;
determine the entity's share of the economic contribution by the activity based on a comparison of the entity's economic contribution and the aggregate economic contribution; and
provide the entity's share of the economic contribution related to the activity.

2. The electronic device of claim 1, wherein estimating the entity's economic contribution comprises estimating the entity's economic contribution based on financial information related to the entity.

3. The electronic device of claim 2, wherein the financial information comprises revenue.

4. The electronic device of claim 2, wherein estimating an aggregate economic contribution by multiple entities comprises manipulating financial information related to the entity by the economic contribution factor.

5. The electronic device of claim 1, wherein estimating the entity's economic contribution comprises estimating the economic contribution of multiple subsets of the entity.

6. A non-transitory machine-readable storage medium encoded with instructions executable by a processor to determine an entity's share of environmental burden caused by an activity, comprising instructions to:
estimate the entity's environmental burden related to the activity based on an environmental burden factor associated with the entity's performance of the activity;
estimate an aggregate environmental burden of multiple entities related to the activity based on an aggregate environmental burden factor associated with the multiple entities' performance of the activity;
determine the entity's share of the environmental burden caused by the activity based on a comparison of the entity's environmental burden and the aggregate environmental burden; and
provide the entity's share of the environmental burden.

7. The machine-readable storage medium of claim 6, wherein estimating the entity's environmental burden further comprises estimating the entity's environmental burden based on financial information related to the entity.

8. The machine-readable storage medium of claim 6, wherein estimating the aggregate environmental burden further comprises estimating the aggregate environmental burden based on financial information related to the entity.

9. The machine-readable storage medium of claim 6, wherein estimating the entity's environmental burden comprises estimating the environmental burden of multiple subsets of the entity.

10. The machine-readable storage medium of claim 9, wherein estimating the environmental burden of multiple subsets of the entity comprises estimating the environmental burden based on financial information related to each of the multiple subsets of the entity.

11. A method to determine an entity's impact related to an activity, comprising:
determining, by a processor, the entity's impact based on a comparison of the entity's share of economic contribution related to the activity relative to other entities and the entity's share of environmental burden related to the activity relative to other entities; and
providing, by a processor, information indicating the entity's impact.

12. The method of claim 11, further comprising classifying the entity based on the entity's impact.

13. The method of claim 11, further comprising determining a risk of regulation based on the entity's impact.

14. The method of claim 11 further comprising estimating the entity's share of he economic contribution related to the activity relative to other entities comprising:
estimating the entity's economic contribution related to the activity;
estimating an aggregate economic contribution by multiple entities related to the activity; and
comparing the entity's economic contribution and the aggregate economic contribution.

15. The method of claim 11, further comprising estimating the entity's share of environmental burden related to the activity relative to other entities, comprising:
estimating the entity's environmental burden related to the activity;
estimating an aggregate environmental burden of multiple entities related to the activity; and
comparing the entity's environmental burden and the aggregate environmental burden.
